(19) United States
(12) Patent Application Publication
(10) Pub. No.: US 2013/0240158 A1
(43) Pub. Date: Sep. 19, 2013

(54) BLIND STRUCTURE

(71) Applicant: Hsiao-Yin CHEN, New Taipei City (TW)

(72) Inventor: Hsiao-Yin CHEN, New Taipei City (TW)

(21) Appl. No.: 13/418,791

(22) Filed: Mar. 13, 2012

(51) Int. Cl. E06B 9/30

(52) U.S. Cl. 160/168.1 R

(57) ABSTRACT

A blind structure is formed by adhering plural soft materials and is expanded and collected vertically by using a cord. Each soft material is in a loop shape and the blind structure is formed by interconnecting two neighboring soft materials with an adhesive agent. Plural through-holes are provided between the two neighboring soft materials, allowing the cord to be transfixed into these through-holes. Accordingly, the vertical expansion and collection of the blind is controlled by the cord and the loop-shaped soft material can achieve a double-layered blind effect when being expanded. Moreover, the cord can be contained completely in the soft material to be hidden completely, thereby providing a blind that is provided with a better light shading effect and can be used more safely.

### BACKGROUND OF THE INVENTION

a) Field of the Invention

The present invention relates to a blind structure, and more particularly to a blind that is provided with an effect of hiding cords.

b) Description of the Prior Art

A blind is currently used by every family or indoor space. The existing blind is mostly controlled by cords to expand or collect curtains.

Referring to FIG. 1, it shows a blind structure relative to a conventional curtain. Most blinds on an existing market will manifest a layered object hanging from top to bottom while being expanded vertically, as shown in FIG. 1. On the other hand, after being collected, the blind are parallel arranged piece by piece (not shown in the drawing).

However, as shown in FIG. 1, when being expanded, the blind manifests a layer and cords A thereof are provided behind the blind. Thus, when the blind is in use, the cords A will be suspended between blind B and a window (not shown in the drawing). Although the cords A are not exposed outside, as there is a distance between the blind B and the window, when a child is playing the blind, the child will be easily strangled by the cords A between the blind B and the window, resulting in a big hidden problem in a daily life of the child. In an actual society, it is often heard that a child was accidentally strangled by a cord of a blind, causing a regret that cannot be compensated.

### SUMMARY OF THE INVENTION

Accordingly, the primary object of the present invention is to provide a blind structure that is provided with a better light shading effect and is able to hide the cords completely, allowing the blind to be used more safely.

To achieve the aforementioned object, the blind structure, according to the present invention, is constituted primarily by adhering plural soft materials. The blind is expanded and collected vertically by a cord and each soft material is in a loop shape. Each soft material is connected with the other using a binding agent between the two neighboring soft materials and in a place that the two neighboring soft materials are connected is provided with plural through-holes, allowing the cord to be transfixed into these through-holes.

Accordingly, the blind is expanded or collected vertically by the cord and when the loop-shaped soft materials are expanded, a double-layered blind effect can be achieved. Moreover, the cord can be contained completely in the soft materials, achieving an effect of hiding the cord completely, so as to provide a blind that is provided with a better light shading effect and can be used more safely.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a blind structure relative to a conventional curtain.

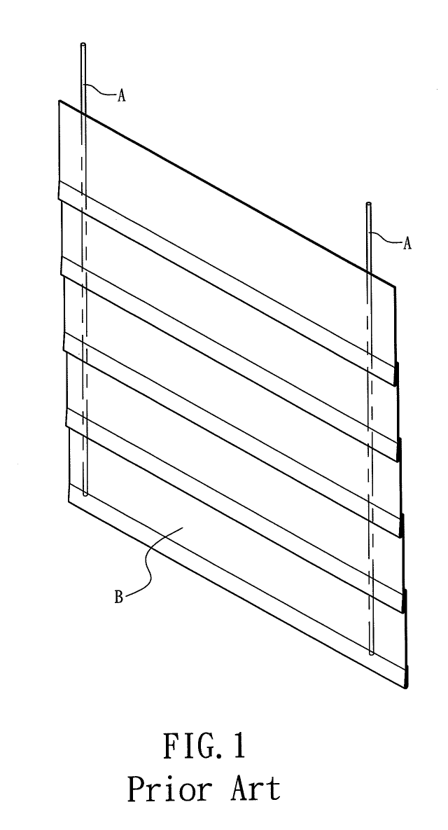

FIG. 2 shows a three-dimensional schematic view of a first embodiment of the present invention.

FIG. 2A shows an exploded view of a single blind structure of the present invention.

FIG. 3 shows a partial schematic view of a first cross section of the blind structure of the present invention.

FIG. 3B shows a blow-up diagram at a circle in FIG. 3.

FIG. 4 shows a partial schematic view of a second cross section of the present invention.

FIG. 4C shows a partial exploded view at a circle in FIG. 4.

FIG. 5 shows a schematic view of the present invention, after the blind has been collected.

FIG. 6 shows a perspective schematic view of a second embodiment of the present invention.

FIG. 7 shows a partial schematic view of a cross section of the second embodiment of the present invention.

FIG. 7D shows a blow-up diagram at a circle in FIG. 7.

### DETAILED DESCRIPTION OF THE PREFERRED EMBODIMENTS

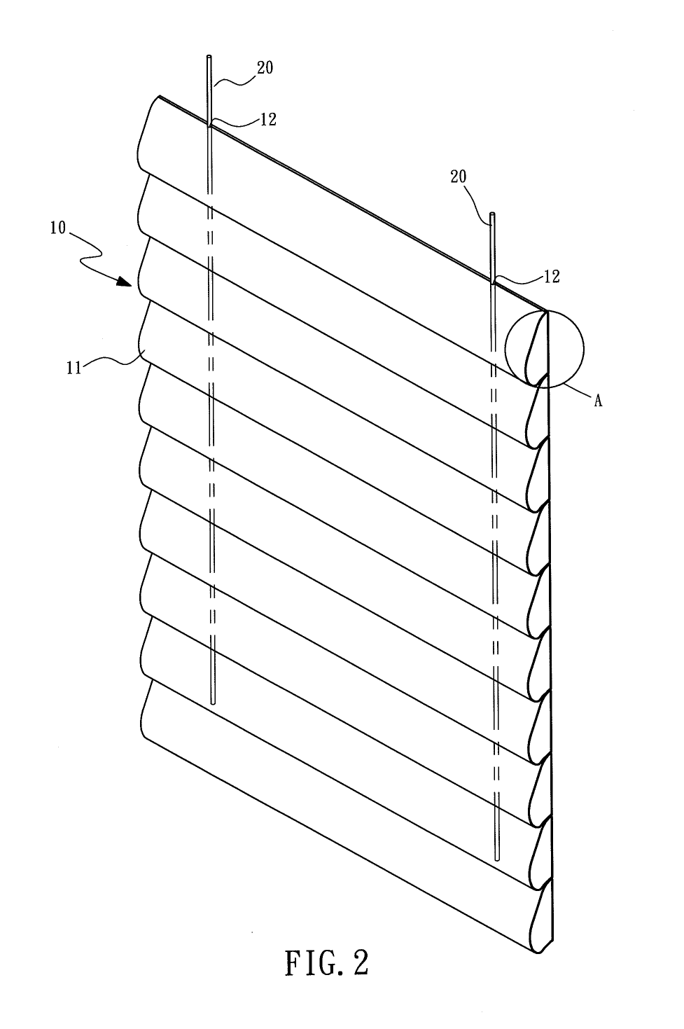

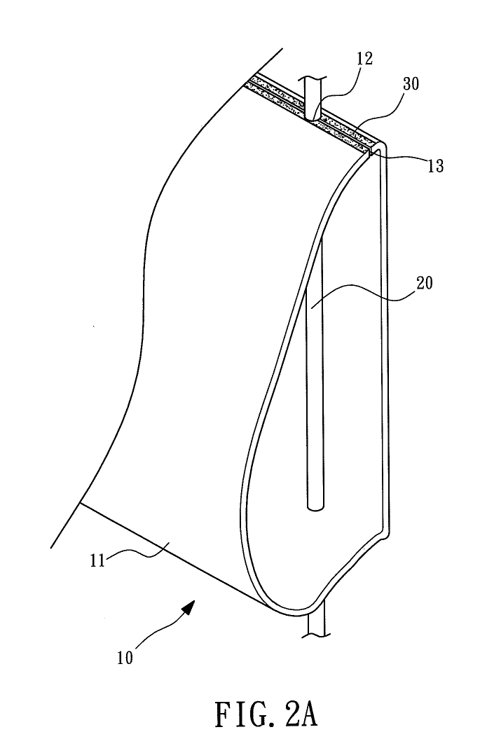

Referring to FIG. 2, it shows a three-dimensional schematic view of a blind structure of the present invention. As shown in the drawing, the blind structure 10 is constituted by interconnecting plural loop-shaped soft materials 11; the soft material 11 can be cloth.

Referring to FIG. 2A at a same time, it shows a blow-up diagram of a single blind structure of the present invention. As shown in the drawing, each soft material 11 is in a loop shape and is formed by looping a soft material 11 in a shape of a long stripe. Hence, each soft material 11 is formed with an opening 13, and two sides of the opening 13 are pasted respectively with a binding agent 30. In addition, the opening of each loop-shaped soft material 11 is provided with plural through-holes 12, allowing at least a cord 20 to be transfixed into these through-holes 12.

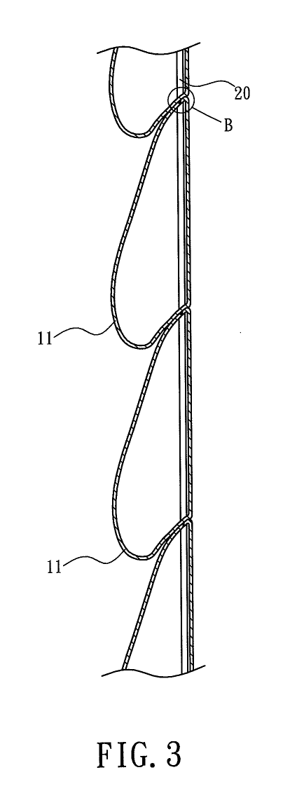

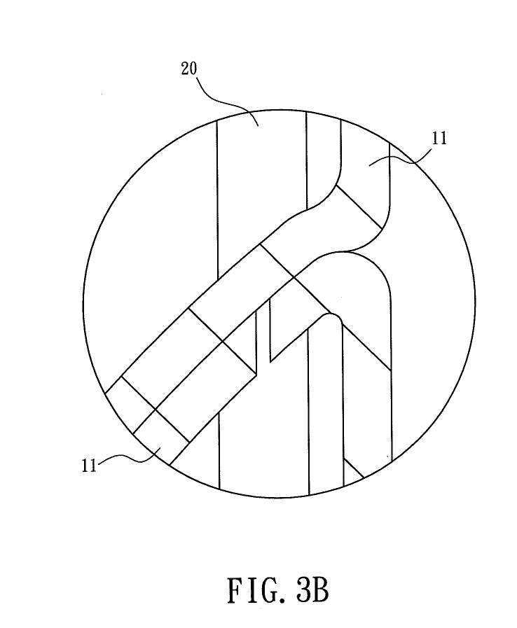

Referring to FIG. 3, it shows a partial schematic view of a first cross section of the blind structure of the present invention. As shown in the drawing, each soft material 11 is in a loop shape and an adhesive agent (not shown in the drawing) is applied between two neighboring soft materials 11, allowing each soft material 11 to be interconnected.

Referring to FIG. 3B at a same time, it shows a partial exploded view at a circle in FIG. 3. As shown in the drawing, the soft material 11 of the present invention is formed primarily by looping a soft material 11 in a shape of a long stripe. As the soft material 11 is in a loop shape, when the blind structure is expanded, each soft material 11 will form a double-layered effect, thereby obtaining a better light shading effect.

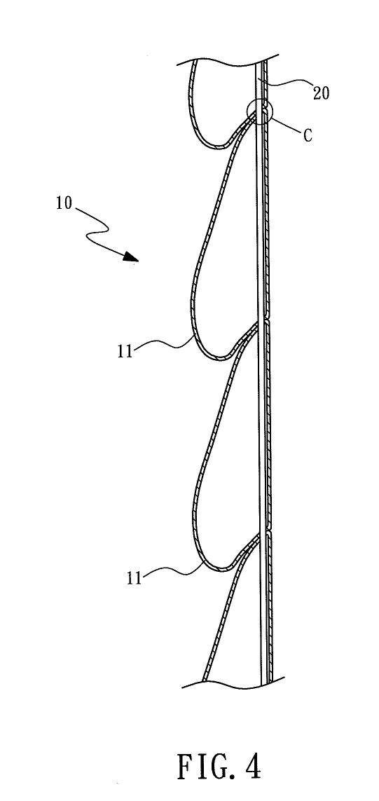

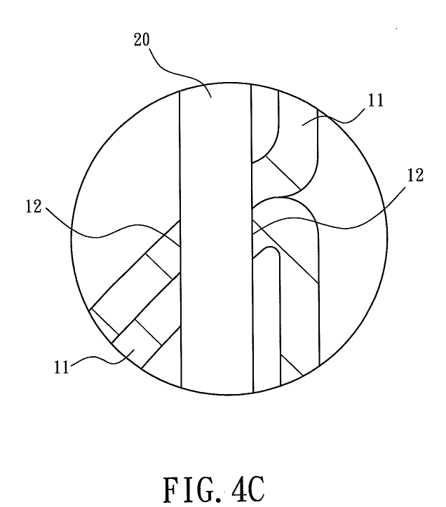

Referring to FIG. 4, it shows a partial schematic view of a second cross section of the blind structure of the present invention. Referring to FIG. 2A at a same time, for the blind structure 10 of the present invention, plural through-holes 12 are provided between the two neighboring soft materials 11, allowing the cord 20 to pass through these through-holes 12 to connect these soft materials 11. A pitch of the through-holes 12 on each soft material 11 can be adjusted according to length of the soft material 11.

Referring to FIG. 4C at a same time, it shows a blow-up diagram at a circle in FIG. 4. As shown in the drawing, as the soft material of the present invention is in a loop shape, when the through-holes 12 are provided between the two neighboring soft materials 11 that the cords 20 can pass through these through-holes 12, the cords 20 will be hidden in the loop-shaped soft materials 11. Therefore, when the blind structure 10 of the present invention is applied on a window (not shown in the drawing), the cords 20 will no longer be exposed between the blind structure 10 and the window. As a result, it can effectively avoid causing a child to be strangled accidentally, thereby providing a blind that is used more safely.

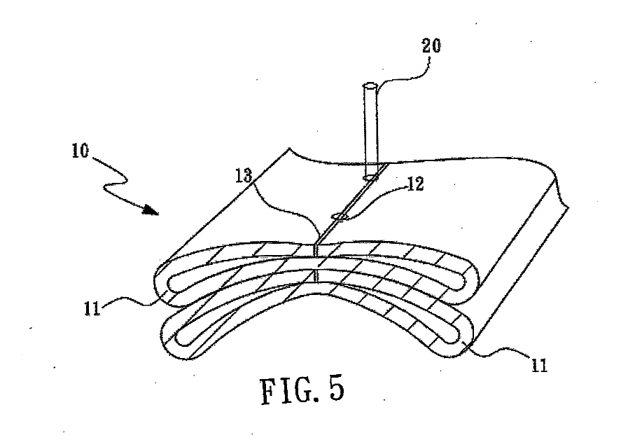

Referring to FIG. 5, it shows a schematic view of the blind structure of the present invention, after being collected. As shown in the drawing, as the cord 20 is transfixed between the two neighboring soft materials 11, when the blind structure 10 is collected, the loop-shaped soft material 11 will be suspending at two sides of the cord 20 against the cord 20, and manifest a state of stack. This can also increase aesthetics after the blind structure has been collected.

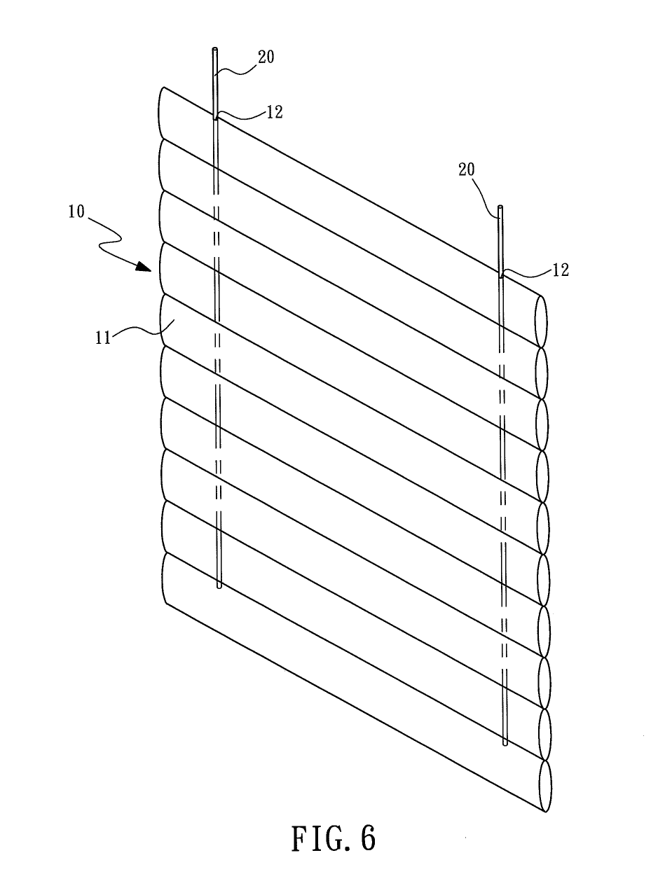

Referring to FIG. 6, it shows a perspective schematic view of a second embodiment of the present invention. The blind structure 10 of the present invention is formed by interconnecting plural loop-shaped soft materials 11; the soft material 11 can be cloth, paper or non-woven fabric.

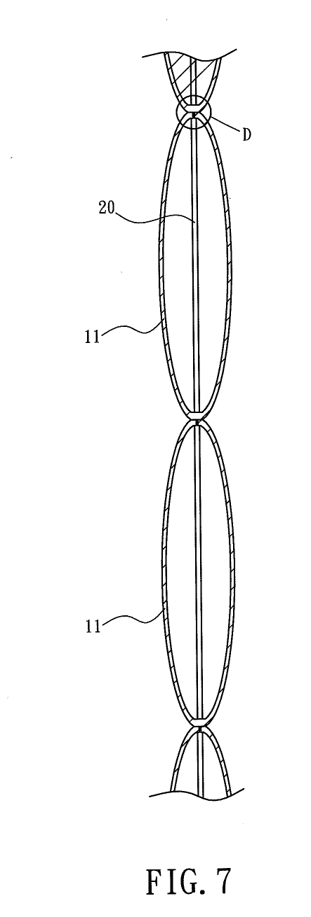

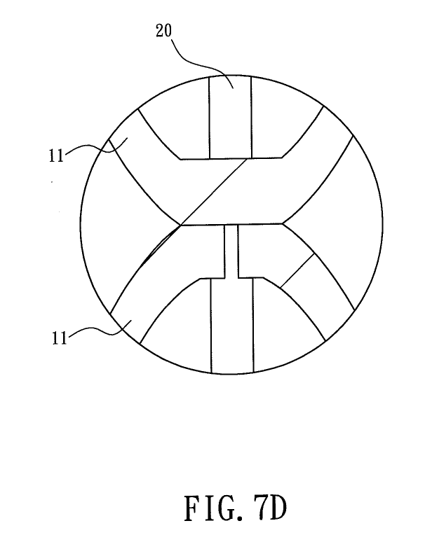

Referring to FIG. 7, it shows a partial schematic view of a cross section of the second embodiment of the present invention. As shown in the drawing, each soft material 11 is in a loop shape and an adhesive agent (not shown in the drawing) is pasted between the two neighboring soft materials 11, allowing the soft materials 11 to be interconnected.

Referring to FIG. 7D, it shows a blow-up diagram at a circle in FIG. 7. As shown in the drawing, the soft material 11 of the present invention is formed primarily by looping a soft material 11 in a shape of a long stripe. As the soft material 11 is in a loop shape, when the blind structure of the present invention is expanded, each soft material 11 will form a double-layered effect, thereby achieving a better light shading effect.

It is worth of mentioning that as the blind structure 10 of the present invention is formed by interconnecting plural loop-shaped soft materials 11 with the adhesive agent, a non-seem effect will be formed on the entire blind structure 10 and no excessive connecting components will be needed. Moreover, each soft material 11 can be also manufactured into a different color, thereby achieving more color variations to increase a fun of using the blind.

In addition, in entire blind structure 10 of the present invention, locations of the through-holes 12, the opening 13 and the cords 20, in the loop-shaped soft materials 11, are dependent upon the length and a draping property of the soft materials 11.

It is of course to be understood that the embodiments described herein is merely illustrative of the principles of the invention and that a wide variety of modifications thereto may be effected by persons skilled in the art without departing from the spirit and scope of the invention as set forth in the following claims.

1. A blind structure comprising a plurality of soft materials with an adhesive agent and being expanded and collected vertically by using a cord, wherein each soft material is in a loop shape and an adhesive agent is applied between the two neighboring soft materials to interconnect into the blind structure; plural through-holes being provided between the two neighboring soft materials, thereby allowing the cord to be transfixed into the through-holes and to be hidden in the soft materials,
wherein two ends of a long stripe of the soft material are adhered together to form the loop shape having a single adhered portion, and
wherein at least some of the plural through-holes are provided through the single adhered portion of each respective soft material.

2. (canceled)

3. The blind structure according to claim 1, wherein the soft material is cloth or paper.

4. The blind structure according to claim 1, wherein each soft material manifests a different color.

5. The blind structure according to claim 1, wherein locations of the through-holes and the cord are dependent upon length and a draping property of the soft materials.
